(19) United States
(12) Patent Application Publication
(10) Pub. No.: US 2005/0032629 A1
(43) Pub. Date: Feb. 10, 2005

(54) Catalyst system to manufacture low sulfur fuels

(76) Inventors: Stuart S. Shih, Baton Rouge, LA (US); David L. Stem, Baton Rouge, LA (US); Madhav Acharya, Vienna, VA (US); Robert C. Welch, Baton Rouge, LA (US); Gordon F. Stuntz, Baton Rouge, LA (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 10/887,678

(22) Filed: Jul. 9, 2004

Related U.S. Application Data
(60) Provisional application No. 60/492,080, filed on Aug. 1, 2003.

(51) Int. Cl. B01J 29/06

(52) U.S. Cl. 502/66; 502/64; 502/71

(57) ABSTRACT

The instant invention relates to a catalyst system used in the production of high octane, low sulfur naphtha products through skeletal isomerization of feed olefins and hydrotreating with the optional removal of basic nitrogen-containing compounds.

### CROSS REFERENCE TO RELATED APPLICATION

This application claims benefit of U.S. Provisional Patent Application Ser. No. 60/492,080 filed Aug. 1, 2003.

### FIELD OF THE INVENTION

The instant invention relates to a catalyst system used in the upgrading of hydrocarbon mixtures boiling within the naphtha range. More particularly, the instant invention relates to a catalyst system used in the production of high octane, low sulfur naphtha products through skeletal isomerization of feed olefins and hydrotreating with optional removal of basic nitrogen-containing compounds.

### BACKGROUND OF THE INVENTION

Liquid hydrocarbon streams that boil within the naphtha range, i.e., below about 232° C., and produced from the Fluidized Catalytic Cracking Unit (“FCC”) are typically used as blending components for motor gasolines. Environmentally driven regulatory pressure concerning motor gasoline sulfur levels is expected to result in the widespread production of less than 50 wppm sulfur mogas by the year 2004. Levels below 10 wppm are being considered for later years in some regions of the world, and this will require deep desulfurization of naphthas in order to conform to emission restrictions that are becoming more stringent. The majority, i.e., 90% or more, of sulfur contaminants present in motor gasolines are typically present in naphtha boiling range hydrocarbon streams. However, the naphtha boiling range streams are also rich in olefins, which boost octane, a desirable quality in motor gasolines.

Thus, many processes have been developed that use catalysts that produce low sulfur products from naphtha boiling range streams while attempting to minimize olefin loss, such as, for example, hydrodesulfurization processes. However, the catalyst systems used in these processes also typically hydrogenate feed olefins to some degree, thus reducing the octane number of the product. Therefore, processes have been developed that utilize catalyst systems directed at recovering octane lost during desulfurization. Non-limiting examples of these processes can be found in U.S. Pat. Nos. 5,298,150; 5,320,742; 5,326,462; 5,318,690; 5,360,532; 5,500,108; 5,510,016; and 5,554,274, which are all incorporated herein by reference. In these processes, in order to obtain desirable hydrodesulfurization with a reduced octane loss, it is necessary to operate in two steps. The first step employs a hydrodesulfurization catalyst, and a second step employs a catalyst aimed at recovering octane lost during hydrodesulfurization.

Other processes have also been developed that utilize catalysts and/or process conditions that seek to minimize octane lost during hydrodesulfurization. For example, selective hydrodesulfurization is used to remove organically bound sulfur while minimizing hydrogenation of olefins and octane reduction by various techniques, such as the use of selective catalysts and/or process conditions. For example, one selective hydrodesulfurization process, referred to as SCANfining, has been developed by ExxonMobil Research & Engineering Company in which olefinic naphthas are selectively desulfurized with little loss in octane. U.S. Pat. Nos. 5,985,136; 6,013,598; and 6,126,814, all of which are incorporated by reference herein, disclose various aspects of SCANfining. Although selective hydrodesulfurization processes have been developed to avoid significant olefin saturation and loss of octane, such processes have a tendency to liberate H₂S a portion of which may react with retained olefins to form mercaptan sulfur by reversion.

Thus, there still exists a need in the art for a catalyst system that can be used in processes that reduce the sulfur content in naphtha boiling range hydrocarbon streams while minimizing octane loss.

### BRIEF DESCRIPTION OF THE FIGURES

FIG. 1 shows research octane versus desulfurization results from the example.

FIG. 2 shows iso-olefin to n-olefin ratio results from the example.

FIG. 3 shows iso-paraffin to n-paraffin ratio results from the example.

### SUMMARY OF THE INVENTION

The instant invention is directed at a catalyst system used in processes for producing low sulfur naphtha products. The catalyst system comprises:
a) at least one first catalyst comprising at least one zeolite having an alpha value in the range of about 1 to about 100; and
b) at least one second catalyst selected from hydrotreating catalysts comprising about 2 to 20 wt. % of a Group VIII metal oxide, about 1 to 50 wt. % of a Group VI metal oxide, and having a median pore diameter of about 60Å to about 200Å to produce a desulfurized product.

In one embodiment of the instant invention, an acidic material effective at removing nitrogen-containing contaminants is optionally used as a pretreatment catalyst. Thus, the catalyst system in this embodiment comprises:
a) at least one acidic material effective at removing or converting nitrogen-containing compounds;
b) at least one first catalyst comprising at least one zeolite having an alpha value in the range of about 1 to about 100; and
c) at least one second catalyst selected from hydrotreating catalysts comprising about 0.1 to 27 wt. % of a Group VIII metal oxide, about 1 to 45 wt. % of a Group VI metal oxide, and having a median pore diameter of about 60Å to about 200Å.

### DETAILED DESCRIPTION OF THE INVENTION

It should be noted that the terms “hydrotreating” and “hydrodesulfurization” are sometimes used interchangeably herein, and the prefixes “i-” and “n” are meant to refer to “iso-” and “normal”.

In the hydrotreating of naphtha boiling range feedstreams, olefins are typically saturated in the hydrotreating zone resulting in a decrease in octane number of the desulfurized product. However, the present catalyst system reduces the decrease in octane of a desulfurized product resulting from a hydroprocessing scheme utilizing it. The first catalyst comprises at least one zeolite having an alpha value in the range of about 1 to about 100, and the second catalyst is selected from hydrotreating catalysts comprising about 0.1 to 27 wt. % of at least one Group VIII metal oxide and about 1 to 45 wt. % of at least one Group VI metal oxide. In one embodiment of the instant invention, the catalyst system further comprises at least one acidic material effective at removing or converting nitrogen-containing compounds.

The desulfurized product thus obtained has a higher iso-paraffin to n-paraffin ratio, and thus a higher octane than a desulfurized naphtha treated by a selective or non-selective hydrotreating process only, i.e., without an octane recovery step. The higher octane of the desulfurized product results from the unexpected finding by the inventors hereof that the first catalyst used herein can be contacted with a naphtha boiling range feedstream under conditions effective for encouraging the skeletal isomerization of n-olefins to iso-olefins. This results in a desulfurized naphtha product having a higher octane number than a desulfurized product produced by a catalyst system employing selective hydrodesulfurization catalysts only. The inventors hereof have found that the degree of skeletal isomerization of n-olefins to iso-olefins benefits the final product because the saturation of iso-olefins to iso-paraffins that occurs in the second reaction zone herein provides for less octane loss in the final product when compared to the saturation of n-olefins to n-paraffins. It should be noted that iso-paraffins typically have a much higher octane than their corresponding n-paraffin. Further, the rate of saturation of iso-olefins is typically slower than that of n-olefins. Therefore, by increasing the ratio of iso-olefins to n-olefins present in the first reaction zone effluent, the resulting desulfurized naphtha product exiting the second reaction zone also has a higher iso-olefin to n-olefin ratio as well as a higher olefin content, and thus a higher octane than a desulfurized naphtha treated by a selective or non-selective hydrotreating process only.

In the hydroprocessing of naphtha boiling range hydrocarbon feedstreams, it is typically highly desirable to remove sulfur-containing compounds from the naphtha boiling range feedstreams with as little olefin saturation as possible. It is also highly desirable to convert as much of the organic sulfur species of the naphtha to hydrogen sulfide with as little mercaptan reversion as possible. By mercaptan reversion we mean the reaction of hydrogen sulfide with olefins during the hydrotreating to form undesirable alkylmercaptans. The inventors hereof have unexpectedly found that the instantly disclosed catalyst system can be used to remove high levels of sulfur from an olefinic naphtha stream without excessive olefin saturation or mercaptan reversion taking place.

Feedstreams suitable for treatment with the presently claimed catalyst system include naphtha boiling range refinery streams, which typically boil in the range of about 50° F. (10° C.) to about 450° F. (232° C.) and contain olefins as well as sulfur-containing compounds. Thus, the term “naphtha boiling range feedstream” as used herein includes those streams having an olefin content of at least about 5 wt. %. Non-limiting examples of naphtha boiling range feedstreams that can be treated by the present invention include fluid catalytic cracking unit naphtha (FCC catalytic naphtha or cat naphtha), steam cracked naphtha, and coker naphtha. Also included are blends of olefinic naphthas with non-olefinic naphthas as long as the blend has an olefin content of at least about 5 wt. %, based on the total weight of the naphtha feedstream.

Cracked naphtha refinery streams generally contain not only paraffins, naphthenes, and aromatics, but also unsaturates, such as open-chain and cyclic olefins, dienes, and cyclic hydrocarbons with olefinic side chains. The olefin-containing naphtha feedstream can contain an overall olefins concentration ranging as high as about 70 wt. %, more typically as high as about 60 wt. %, and most typically from about 5 wt. % to about 40 wt. %. The olefin-containing naphtha feedstream can also have a diene concentration up to about 15 wt. %, but more typically less than about 5 wt. % based on the total weight of the feedstock. The sulfur content of the naphtha feedstream will generally range from about 50 wppm to about 7000 wppm, more typically from about 100 wppm to about 5000 wppm, and most typically from about 100 to about 3000 wppm. The sulfur will usually be present as organically bound sulfur. That is, as sulfur compounds such as simple aliphatic, naphthenic, and aromatic mercaptans, sulfides, di- and polysulfides and the like. Other organically bound sulfur compounds include the class of heterocyclic sulfur compounds such as thiophene, tetrahydrothiophene, benzothiophene and their higher homologs and analogs. Nitrogen can also be present in a range from about 5 wppm to about 500 wppm. Thus, one embodiment of the instant invention employs a pretreatment acidic material capable of removing at least a portion of the nitrogen present in the feedstreams.

In a process employing the presently claimed catalyst system, the feedstreams described above are typically preheated prior to contacting the first catalyst, with final heating targeted to the temperatures in the reaction containing the second catalyst. If the naphtha boiling range feedstream is preheated, it can be reacted with hydrogen-containing treat gas stream prior to, during, and/or after preheating. At least a portion of the hydrogen-containing treat gas can also be added at an intermediate location in the first reaction zone. Hydrogen-containing treat gasses suitable for use in processes employing the presently claimed catalyst system presently disclosed process can be comprised of substantially pure hydrogen or can be mixtures of other components typically found in refinery hydrogen streams.

The first catalyst of the presently claimed catalyst system comprises at least one zeolite. Zeolites are porous crystalline materials and those used herein as the first catalyst have an alpha value in the range of about 1 to about 100, preferably between about 2 and 80, more preferably between about 5 and 50, and most preferably between about 10 and 30. Alpha value, or alpha number, is a measure of zeolite acidic functionality and is more fully described together with details of its measurement in U.S. Pat. No. 4,016,218, J. Catalysis, 6, pages 278-287 (1966) and J. Catalysis, 61, pages 390-396 (1980), which are all incorporated herein by reference. Generally the alpha value reflects the relative activity with respect to a high activity silica-alumina cracking catalyst. To determine the alpha value as used herein, n-hexane conversion is determined at about 800° F. Conversion is varied by variation in space velocity such that a conversion level of 10 to 60 percent of n-hexane is obtained and converted to a rate constant per unit volume of zeolite and compared with that of the silica-alumina catalyst, which is normalized to a reference activity of 1000° F. Catalytic activity is expressed as a multiple of this standard, i.e., the silica-alumina standard. The silica-alumina reference catalyst contains about 10 wt. % Al₂O₃ and the remainder is SiO₂. Therefore, as the alpha value of a zeolite catalyst decreases, the tendency towards non-selective cracking also decreases.

Zeolites suitable for use as the first catalyst of the presently claimed catalyst system herein include both large and medium pore zeolites, with Beta and medium pore zeolites being preferred. Medium pore zeolites as used herein can be any zeolite described as a medium pore zeolite in Atlas of Zeolite Structure Types, W. M. Maier and D. H. Olson, Butterworths. Typically, medium pore zeolites are defined as those having a pore size of about 5 to about 7 Angstroms, such that the zeolite freely sorbs molecules such as n-hexane, 3-methylpentane, benzene and p-xylene. Another common classification used for medium pore zeolites involves the Constraint Index test which is described in U.S. Pat. No. 4,016,218, which is hereby incorporated by reference. Medium pore zeolites typically have a Constraint Index of about 1 to about 12, based on the zeolite alone without modifiers and prior to treatment to adjust the diffusivity of the catalyst. Preferred medium pore zeolites for use herein are selected from the group consisting of ZSM-23 ZSM-12, ZSM-22, ZSM-35, ZSM-57, and ZSM-48, more preferred medium pore zeolites are selected from ZSM-23, ZSM-12, ZSM-22, ZSM-57, and ZSM-48, with ZSM-48 being the most preferred. ZSM-48 also is the most preferred first catalyst.

The first catalyst may be combined with a suitable porous binder or matrix material. Non-limiting examples of such materials include active and inactive materials such as clays, silica, and/or metal oxides such as alumina. Non-limiting examples of naturally occurring clays that can be composited include clays from the montmorillonite and kaolin families including the subbentonites, and the kaolins commonly known as Dixie, McNamee, Georgia, and Florida clays. Others in which the main mineral constituent is halloysite, kaolinite, dickite, nacrite, or anauxite may also be used. The clays can be used in the raw state as originally mixed or subjected to calcination, acid treatment, or chemical modification prior to being combined with the at least one zeolite.

It is preferred that the porous matrix or binder material comprises at least one of silica, alumina, or a kaolin clay. It is more preferred that the binder material comprise alumina. In this embodiment the alumina is present in a ratio of less than about 15 parts zeolite to one part binder, preferably less than about 10, more preferably less than about 5, and most preferably about 2.

The first catalyst can be arranged in one or more fixed bed reactors or reaction zones each of which can comprise one or more catalyst beds of the same first catalyst. Although the first catalyst can be arranged in other types of catalyst beds, fixed beds are preferred. Such other types of catalyst beds include fluidized beds, ebullating beds, slurry beds, and moving beds. When utilizing the present catalyst system, interstage cooling between reactors, or between catalyst beds in the same reactor, can be employed since some olefin saturation can take place, and olefin saturation and the desulfurization reaction are generally exothermic. A portion of the heat generated during processes employing the presently claimed catalyst system can be recovered. Where this heat recovery option is not available, conventional cooling may be performed through cooling utilities such as cooling water or air, or through use of a hydrogen quench stream. In this manner, optimum reaction temperatures can be more easily maintained.

In practicing utilizing the present catalyst system in a hydroprocessing scheme, the first catalyst is placed in a first reaction zone operated under effective isomerization conditions. By effective isomerization conditions, it is meant those conditions that provide for the skeletal isomerization of at least about 20 wt. % of the n-olefins present in the feedstream to iso-olefins. By skeletal isomerization, it is meant the reorientation of the molecular structure of the normal olefins (n-olefins) with a preference for branched chain iso-olefins over straight. Thus, skeletal isomerization, as used herein, refers to the conversion of a normal olefin to a branched olefin or to the rearranging or moving of branch carbon groups, which are attached to the straight chain olefin molecule, to a different carbon atom, and non-skeletal isomerization can be described as the rearranging of the position of the double bond within the straight chain or branched olefin molecule. These conditions typically include temperatures ranging from about 150° C. to about 425° C., weight hourly space velocities (“WHSV”) ranging from about 0.1 to about 20hr⁻¹, and pressures typically range from about 4 to about 70 atmospheres.

Processes employing the present catalyst system typically produce at least a first reaction zone effluent. This first reaction zone effluent is then passed to a second reaction zone wherein the first reaction zone effluent is contacted with the second catalyst of the instant catalyst system. The second catalyst can also be arranged in one or more fixed bed reactors or reaction zones each of which can comprise one or more catalyst beds of the same catalyst. Non-limiting examples of suitable bed types include fluidized beds, ebullating beds, slurry beds, and moving beds. It is preferred that the second catalyst be arranged in a fixed catalyst bed, and it is more preferred that the first and second catalysts be located within in the same reaction vessel. In utilizing the instant catalyst system in a hydroprocessing scheme, interstage cooling between reactors or reaction zones, or between catalyst beds in the same reactor, can be employed since some olefin saturation can take place, and olefin saturation and the desulfurization reaction are generally exothermic. A portion of the heat generated during hydrodesulfurization can be recovered. Where this heat recovery option is not available, conventional cooling may be performed through cooling utilities such as cooling water or air, or through use of a hydrogen quench stream. In this manner, optimum reaction temperatures can be more easily maintained.

Suitable second catalysts are those that are comprised of at least one Group VIII metal oxide, preferably an oxide of a metal selected from Fe, Co and Ni, more preferably Co and/or Ni, and most preferably Co; and at least one Group VI metal oxide, preferably an oxide of a metal selected from Mo and W, more preferably Mo, on a high surface area support material, preferably alumina. Other suitable second catalysts include zeolitic catalysts, as well as noble metal catalysts where the noble metal is selected from Pd and Pt. It is within the scope of the present invention that more than one type of catalyst be used in the same reaction vessel. The Group VIII metal oxide of the second catalysts is typically present in an amount ranging from about 2 to about 20 wt. %, preferably from about 4 to about 12%. The Group VI metal oxide will typically be present in an amount ranging from about 1 to about 50 wt. %, preferably from about 1 to about 10 wt. %, and more preferably from about 1 to about 5 wt. %. All metal oxide weight percents are on support. By “on support” we mean that the percents are based on the weight of the support. For example, if the support were to weigh 100 g. then 20 wt. % Group VIII metal oxide would mean that 20 g. of Group VIII metal oxide was on the support.

Preferred second catalysts will also have a high degree of metal sulfide edge plane area as measured by the Oxygen Chemisorption Test described in “Structure and Properties of Molybdenum Sulfide: Correlation of O₂ Chemisorption with Hydrodesulfurization Activity,” S. J. Tauster et al., Journal of Catalysis 63, pp 515-519 (1980), which is incorporated herein by reference. The Oxygen Chemisorption Test involves edge-plane area measurements made wherein pulses of oxygen are added to a carrier gas stream and thus rapidly traverse the catalyst bed. For example, the oxygen chemisorption will be from about 800 to 2,800, preferably from about 1,000 to 2,200, and more preferably from about 1,200 to 2,000 μmol oxygen/gram MoO₃.

The most preferred second catalysts can be characterized by the properties: (a) a MoO₃ concentration of about 1 to 25 wt. %, preferably about 2 to 10 wt. %, and more preferably about 3 to 6 wt. %, based on the total weight of the catalyst; (b) a CoO concentration of about 0.1 to 6 wt. %, preferably about 0.5 to 5 wt. %, and more preferably about 1 to 3 wt. %, also based on the total weight of the catalyst; (c) a Co/Mo atomic ratio of about 0.1 to about 1.0, preferably from about 0.20 to about 0.80, more preferably from about 0.25 to about 0.72; (d) a median pore diameter of about 60 Å to about 200 Å, preferably from about 75 Å to about 175Å, and more preferably from about 80 Å to about 150 Å; (e) a MoO₃ surface concentration of about 0.5×10⁻⁴ to about 3×10⁻⁴ g. MoO₃/m², preferably about 0.75×10⁻⁴ to about 2.5×10⁻⁴, more preferably from about 1×10⁻⁴ to 2×10⁻⁴; and (f) an average particle size diameter of less than 2.0 mm, preferably less than about 1.6 mm, more preferably less than about 1.4 mm, and most preferably as small as practical for a commercial hydrodesulfurization process unit.

The second catalysts of the present invention are preferably supported catalysts. Any suitable refractory catalyst support material, preferably inorganic oxide support materials may be used as supports for the catalyst of the present invention. Non-limiting examples of suitable support materials include: zeolites, alumina, silica, titania, calcium oxide, strontium oxide, barium oxide, carbons, zirconia, diatomaceous earth, lanthanide oxides including cerium oxide, lanthanum oxide, neodymium oxide, yttrium oxide, and praseodymium oxide; chromia, thorium oxide, urania, niobia, tantala, tin oxide, zinc oxide, and aluminum phosphate. Preferred are alumina, silica, and silica-alumina. More preferred is alumina. Magnesia can also be used for the second reaction zone catalysts. It is to be understood that the support material can also contain small amounts of contaminants, such as Fe, sulfates, silica, and various metal oxides that can be introduced during the preparation of the support material. These contaminants are present in the raw materials used to prepare the support and will preferably be present in amounts less than about 1 wt. %, based on the total weight of the support. It is more preferred that the support material be substantially free of such contaminants. It is an embodiment of the present invention that about 0 to 5 wt. %, preferably from about 0.5 to 4 wt. %, and more preferably from about 1 to 3 wt. %, of an additive be present in the support, which additive is selected from the group consisting of phosphorus and metals or metal oxides from Group IA (alkali metals) of the Periodic Table of the Elements.

As previously stated, in a typical hydroprocessing scheme employing the instant catalyst system, a first stage effluent is contacted with the second catalyst under effective hydrotreating conditions in a second reaction zone. By effective hydrotreating conditions, it is meant those conditions chosen that will achieve a resulting desulfurized naphtha product having less than 100 wppm sulfur, preferably less than 50 wppm sulfur, more preferably less than 30 wppm sulfur. These conditions typically include temperatures ranging from about 150° C. to about 425° C., preferably about 200° C. to about 370° C., more preferably about 230° C. to about 350° C. Typical weight hourly space velocities (“WHSV”) range from about 0.1 to about 20hr⁻¹, preferably from about 0.5 to about 5hr⁻¹. Any effective pressure can be utilized, and pressures typically range from about 4 to about 70 atmospheres, preferably 10 to 40 atmospheres. It should be noted that although the range of operating conditions for the second reaction zone is similar to that for the first reaction zone, both reaction zones could operate under different conditions. In a most preferred embodiment, the effective hydrotreating conditions are selective hydrotreating conditions configured to achieve a sulfur level within the above-defined sulfur ranges, most preferably the desulfurized naphtha product has a sulfur level sufficiently low to meet current regulatory standards in place at that time. By selective hydrotreating conditions, it is meant conditions such as those contained in U.S. Pat. Nos. 5,985,136; 6,013,598; and 6,126,814, all of which have already been incorporated by reference herein, which disclose various aspects of SCANfining, a process developed by the ExxonMobil Research and Engineering Company in which olefinic naphthas are selectively desulfurized with little loss in octane.

The desulfurized product obtained from treating the above-described feedstreams with the present catalyst system will have a higher iso-paraffin to n-paraffin ratio, and thus a higher octane than a desulfurized naphtha treated by a selective or non-selective hydrotreating process. Typical iso-paraffin to n-paraffin ratios in the desulfurized product resulting from the present process are typically greater than about 1, preferably about 2, more preferably about 3. Thus, compared to selective hydrodesulfurization catalyst systems, the processing of the naphtha boiling range feedstream over the present catalyst system results in a desulfurized naphtha product with a higher octane at constant olefin saturation even when both catalyst systems maintain similar desulfurization/olefin saturation selectivity.

As previously stated, one embodiment of the presently claimed catalyst system further comprises at least one acidic material effective at removing or converting nitrogen-containing compounds. Non-limiting examples of suitable acidic materials include Amberlyst, alumina, sulfuric acid, and any other acidic material known to be effective at catalyzing the removal of nitrogen compounds from a hydrocarbon stream. It should be noted that if sulfuric acid is selected, the sulfuric acid concentration should be selected to avoid polymerization of olefins. Preferred acidic materials include Amberlyst and alumina.

It should be noted that spent sulfuric acid obtained from an alkylation unit could also be used to remove the nitrogen contaminants. In this embodiment, the spent sulfuric acid can be diluted with water to form a sulfuric acid solution having a sulfuric acid concentration suitable for removing nitrogen contaminants. In a process utilizing sulfuric acid, the sulfuric acid solution is typically mixed with the naphtha boiling range feedstream by mixing valves, mixing tanks or vessels, or through the use of a fixed bed or beds of inert materials. After the spent sulfuric acid and naphtha boiling range feedstream have been in contact under effective conditions, the two are allowed or caused to separate into a sulfuric acid solution phase and an effluent, comprising substantially all of the naphtha boiling range feedstream. This effluent is then contacted with the first catalyst described herein.

The acidic material can be arranged in one or more reactors or reaction zones each of which can comprise the same or different acidic material. In some cases, the acidic material can be present in the form of beds, and fixed beds are preferred.

In a process utilizing this embodiment of the presently claimed catalyst system, the reaction zone containing the acidic material is operated under conditions effective for removal of at least a portion of the nitrogen-containing compounds present in the feedstream. By at least a portion, it is meant at least about 10 wt. % of the nitrogen-containing compounds present in the feedstream.

The above description is directed to several embodiments of the present invention. Those skilled in the art will recognize that other embodiments that are equally effective could be devised for carrying out the spirit of this invention.

The following example will illustrate the improved effectiveness of the present invention, but is not meant to limit the present invention in any fashion.

### EXAMPLE

An FCC naphtha was treated with acidic materials (Amberlyst- 15 and alumina) to remove nitrogen-containing compounds. The naphtha feed having a reduced amount of nitrogen compounds was used in the present example, and its properties are outlined in Table 1 below.

TABLE 1

| API Gravity | 56 | |
|---|---|---|
| Sulfur | 606 | wppm |
| Nitrogen | 1 | wppm |
| Bromine Number | 72 | |
| Research Octane Number | 92.1 | |
| N-Paraffins | 3.22 | wt. % |
| I-Paraffins | 23.22 | wt. % |
| Naphthenes | 8.38 | wt. % |
| Aromatics | 29.69 | wt. % |
| N-Olefins | 11.95 | wt. % |
| I-Olefins | 17.35 | wt. % |
| Other Olefins | 6.20 | wt. % |

| | |
|---|---|
| Distillation | ASTM D2287 |
| 10% | 42° C. |
| 30% | 79° C. |
| 50% | 109° C. |
| 70% | 138° C. |
| 90% | 174° C. |

The feed described in Table 1 above was then subjected to two side-by-side experiments to demonstrate the concept of olefin isomerization/desulfurization to preserve octane of the desulfurized naphtha product. These experiments were conducted in identical down-flow, fixed-bed pilot units that share a common sand bath for control of reactor temperature.

In these experiments, two units, Unit A and Unit B were used to evaluate the effectiveness of the present invention. Unit A utilized a stacked bed configuration and Unit B used a single bed. The catalyst loadings of Unit A were 2.5 cc of ZSM-48 as the first catalyst in the first reaction zone and 2.5 cc of a catalyst comprising 4.3 wt. % MoO₃, 1.2 wt. % CoO, on alumina with a median pore diameter of 95Å was used as the second catalyst in the second reaction zone. Unit B utilized 2.5 cc of a catalyst comprising 4.3 wt. % MoO₃, 1.2 wt. % CoO, on alumina with a median pore diameter of 95Å only.

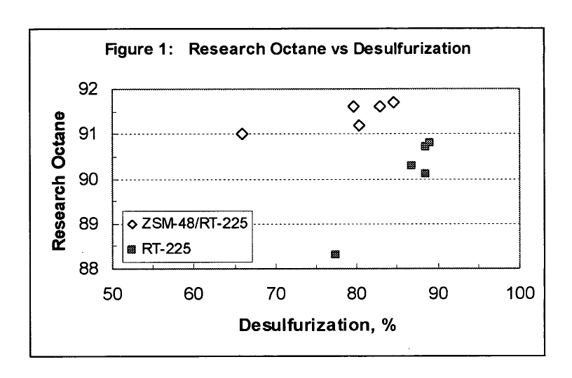

The feed was contacted with the catalyst(s) system contained in both Unit A and Unit B under the same conditions. These conditions included a flow rate of 10 cc/hr, a hydrogen treat gas rate of 59.4 cc/min of substantially pure hydrogen, and a total system pressure of 1.84 MPa. The reactor temperature (sand bath) was varied from 250° C. to 290° C. The results of the two experiments were then evaluated and are contained in FIGS. 1, 2, and 3 below. Based on the results contained in FIGS. 1, 2 and 3, the catalyst system of the instant invention saves octane because the products resulting from treating a naphtha boiling range feed stream with the present process unexpectedly have more branched olefins and paraffins.

FIG. 1 shows that at constant desulfurization, the stacked bed system of Unit A produced a product having a higher research octane number than the catalyst system of Unit B.

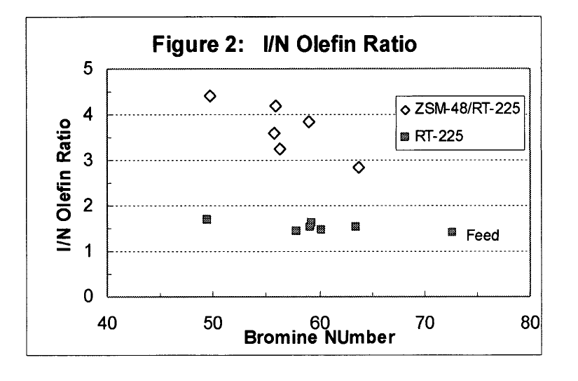

FIG. 2 shows that at constant olefin saturation, the stacked bed catalyst system of Unit A gave a higher iso-olefin to n-olefin ratio in the first reaction zone effluent than the catalyst system of Unit B. The olefin saturation is expressed as a reduction of bromine number (HDBr), which is directly related to the olefin content. The reduction in bromine number was measured according to ASTM 1159.

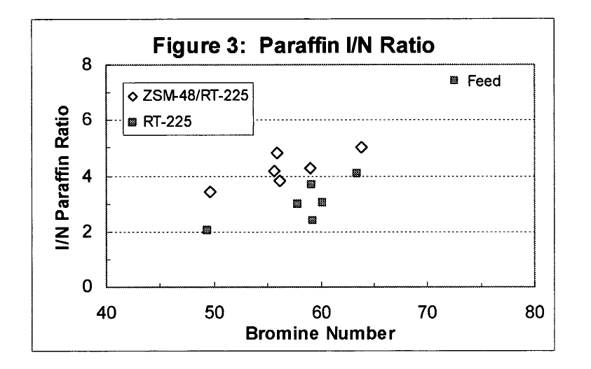

FIG. 3 shows that at constant olefin saturation, the stacked bed catalyst system of Unit A produced a product having a higher iso-paraffin to n-paraffin ratio that the catalyst system of Unit B.

1. A catalyst system used in processes for producing low sulfur naphtha products comprising:
a) a first catalyst selected from medium pore zeolites; and
b) a second catalyst selected from hydrotreating catalysts comprising about 2 to 20 wt. % of a Group VIII metal oxide, about 1 to 50 wt. % of a Group VI metal oxide, and having a median pore diameter of about 60Å to about 200Å to produce a desulfurized product.

2. The catalyst system according to claim 1 wherein said first and second catalysts are arranged in one or more catalyst beds selected from the group consisting of fluidized beds, ebullating beds, slurry beds, fixed beds, and moving beds.

3. The catalyst system according to claim 2 wherein said first and second catalysts are located in the same reaction vessel.

4. The catalyst system according to claim 2 wherein said first catalyst is selected from group consisting of Beta, ZSM-23, ZSM-12, ZSM-22, ZSM-35, ZSM-57, and ZSM-48.

5. The catalyst system according to claim 4 wherein said second catalyst is a hydrotreating catalyst comprising about 1 to 25 wt. % MoO₃, about 0.1 to 6 wt. % CoO wherein said CoO and MoO₃ are present in an atomic ratio of about 0.1 to about 1.0 Co/Mo, and said catalyst has a median pore diameter of about 75 Å to about 175Å, wherein said second catalyst has a MoO₃ surface concentration of about 0.5×10⁻⁴ to about 3×10⁻⁴ g and an average particle size diameter of less than 2.0 mm.

6. The catalyst system according to claim 5 wherein said second catalyst further comprises a suitable binder or matrix material selected from zeolites, alumina, silica, titania, calcium oxide, strontium oxide, barium oxide, carbons, zirconia, diatomaceous earth, lanthanide oxides including cerium oxide, lanthanum oxide, neodymium oxide, yttrium oxide, and praseodymium oxide; chromia, thorium oxide, urania, niobia, tantala, tin oxide, zinc oxide, and aluminum phosphate.

7. The catalyst system according to claim 6 wherein said suitable binder or matrix support of said second catalyst also contains less than about 1 wt. % of contaminants, such as Fe, sulfates, silica, and various metal oxides that can be introduced during the preparation of the support.

8. The catalyst system according to claim 7 wherein said suitable binder or matrix support of said second catalyst also contains about 0 to 5 wt. % of an additive selected from the group consisting of phosphorus and metals or metal oxides from Group IA (alkali metals) of the Periodic Table of the Elements.

9. The catalyst system according to claim 6 wherein said first catalyst further comprises a suitable porous binder or matrix material selected from clays, silica, and/or metal oxides such as alumina.

10. The catalyst system according to claim 9 wherein said suitable porous binder or matrix material is selected from silica, alumina, or a kaolin clay.

11. The process according to claim 9 wherein said suitable porous binder or matrix material is alumina present in a ratio of less than about 15 parts zeolite to one part binder.

12. The catalyst system according to claim 1 wherein said catalyst system further comprises at least one acidic material effective at removing or converting nitrogen-containing compounds.

13. A catalyst system used in processes for producing low sulfur naphtha products comprising:
a) a first catalyst selected from Beta ZSM-23 ZSM-12, ZSM-22, ZSM-57, and ZSM-48; and
b) a second catalyst selected from hydrotreating catalysts comprising about 1 to 25 wt. % MoO₃, about 0.1 to 6 wt. % CoO wherein said CoO and MoO₃ are present in an atomic ratio of about 0.1 to about 1.0 Co/Mo, and said catalyst has a median pore diameter of about 75 Å to about 175Å, wherein said second catalyst has a MoO₃ surface concentration of about 0.75×10⁻⁴ to about 2.5×10⁻⁴ g and an average particle size diameter of less than 2.0 mm.

14. The catalyst system according to claim 13 wherein said first catalyst is ZSM-48.

15. The catalyst system according to claim 14 wherein said second catalyst is a hydrotreating catalyst comprising about 4 to 19 wt. % MoO₃, about 0.5 to 5.5 wt. % CoO wherein said CoO and MoO₃ are present in an atomic ratio of about 0.20 to about 0.80 Co/Mo, and said catalyst has a median pore diameter of about 75 Å to about 175Å, wherein said second catalyst has a MoO₃ surface concentration of about 0.5×10⁻⁴ to about 3×10⁻⁴ g and an average particle size diameter of less than 1.6 mm.

16. The catalyst system according to claim 15 wherein said second catalyst further comprises a suitable binder or matrix material selected from alumina, silica, and silica-alumina.

17. The catalyst system according to claim 16 wherein said suitable binder or matrix material is alumina.

18. The catalyst system according to claim 16 wherein said first catalyst further comprises a suitable porous binder or matrix material selected from clays, silica, and metal oxides.

19. The catalyst system according to claim 16 wherein said first reaction zone catalyst further comprises alumina present in a ratio of less than about 15 parts zeolite to one part binder.

20. The catalyst system according to claim 13 wherein said catalyst system further comprises at least one acidic material effective at removing or converting nitrogen-containing compounds.

21. A catalyst system used in processes for producing low sulfur naphtha products comprising:
a) at least one acidic material effective at removing or converting nitrogen-containing compounds;
b) a first catalyst comprising ZSM-48 and an alumina binder, wherein said binder and ZSM-48 are present in a ratio of less than about 15 parts zeolite to one part binder; and
c) a second catalyst selected from supported hydrotreating catalysts comprising about 5 to 16 wt. % MoO₃, about 1 to 5 wt. % CoO wherein said CoO and MoO₃ are present in an atomic ratio of about 0.25 to about 0.72 Co/Mo, and said catalyst has a median pore diameter of about 80 Å to about 150 Å, wherein said second catalyst has a MoO₃ surface concentration of about 1×10⁻⁴ to 2×10⁻⁴ g and an average particle size diameter of less than 1.4 mm.
